(19) United States
(12) Patent Application Publication
(10) Pub. No.: US 2016/0255564 A1
(43) Pub. Date: Sep. 1, 2016

(54) CELL SELECTION FOR A HIGH SPEED SCENARIO

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/732,488

(22) Filed: Jun. 5, 2015

Related U.S. Application Data
(60) Provisional application No. 62/126,287, filed on Feb. 27, 2015.

(51) Int. Cl. H04W 36/30; H04W 24/08; H04W 4/06; H04W 4/02

(52) U.S. Cl. CPC H04W 36/30; H04W 4/028; H04W 24/08; H04W 4/06

(57) ABSTRACT

A method of wireless communication at a user equipment (UE) includes determining whether a user equipment (UE) is traveling faster than a predetermined speed and determining whether a current serving frequency is dedicated, based on whether the UE is traveling faster than the predetermined speed and/or whether a high-speed flag is set in a received message. The method also includes periodically searching a dedicated frequency from a dedicated frequency list to detect a dedicated cell with a signal quality above a predetermined threshold and switching to the dedicated cell, when the signal quality of the dedicated cell is above the predetermined threshold.

### CROSS-REFERENCE TO RELATED APPLICATION

This application claims the benefit under 35 U.S.C. §119(e) to U.S. Provisional Patent Application No. 62/126,287, entitled “CELL SELECTION FOR A HIGH SPEED SCENARIO,” filed on Feb. 27, 2015, the disclosure of which is expressly incorporated by reference herein in its entirety.

### BACKGROUND

1. Field

Aspects of the present disclosure relate generally to wireless communication systems, and more particularly, to cell selection when in a high speed scenario.

2. Background

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the present disclosure, a method of wireless communication is presented. The method includes determining whether a user equipment (UE) is traveling faster than a predetermined speed. The method further includes determining whether a current serving frequency is dedicated, based on whether the UE is traveling faster than the predetermined speed and/or whether a high-speed flag is set in a received message. The method further includes periodically searching a dedicated frequency from a dedicated frequency list to detect a dedicated cell with a signal quality above a first predetermined threshold, when the current serving frequency is not dedicated. The method also includes switching to the dedicated cell, when the signal quality of the dedicated cell is above the first predetermined threshold.

In another aspect of the present disclosure, an apparatus for wireless communication is presented. The apparatus includes a memory and at least one processor coupled to the memory. The processor(s) is configured to determine whether a user equipment is traveling faster than a predetermined speed. The processor(s) is further configured to determine whether a current serving frequency is dedicated, based on whether the UE is traveling faster than the predetermined speed and/or whether a high-speed flag is set in a received message. The processor(s) is further configured to periodically search a dedicated frequency from a dedicated frequency list to detect a dedicated cell with a signal quality above a first predetermined threshold, when the current serving frequency is not dedicated. The processor(s) is also configured to switch to the dedicated cell, when the signal quality of the dedicated cell is above the first predetermined threshold.

In yet another aspect of the present disclosure, an apparatus for wireless communication is presented. The apparatus includes means for determining whether a user equipment is traveling faster than a predetermined speed. The apparatus further includes means for determining whether a current serving frequency is dedicated, based on whether the UE is traveling faster than the predetermined speed and/or whether a high-speed flag is set in a received message. The apparatus further includes means for periodically searching a dedicated frequency from a dedicated frequency list to detect a dedicated cell with a signal quality above a first predetermined threshold, when the current serving frequency is not dedicated. The apparatus also includes means for switching to the dedicated cell, when the signal quality of the dedicated cell is above the first predetermined threshold.

In still another aspect of the present disclosure, a computer program product for wireless communication is presented. The computer program product includes a non-transitory computer-readable medium having encoded thereon program code. The program code includes program code to determine whether a user equipment (UE) is traveling faster than a predetermined speed. The program code further includes program code to determine whether a current serving frequency is dedicated, based on whether the UE is traveling faster than the predetermined speed and/or whether a high-speed flag is set in a received message. The program code further includes program code to periodically search a dedicated frequency from a dedicated frequency list to detect a dedicated cell with a signal quality above a first predetermined threshold, when the current serving frequency is not dedicated. The program code also includes program code to switch to the dedicated cell, when the signal quality of the dedicated cell is above the first predetermined threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2A is a diagram illustrating an example of a downlink frame structure in LTE.

FIG. 2B is a diagram illustrating an example of an uplink frame structure in LTE.

FIG. 3 is a block diagram conceptually illustrating an example of a base station in communication with a UE in a telecommunications system.

FIG. 4 illustrates exemplary network coverage areas including a dedicated wireless network and a non-dedicated public wireless network according to aspects of the present disclosure.

FIG. 5 is a flow diagram illustrating an example decision process for cell selection in a high speed scenario according to aspects of the present disclosure.

FIG. 6 is a flow diagram illustrating a method for a cell selection in a high speed scenario according to aspects of the present disclosure.

FIG. 7 is a block diagram illustrating different modules/means/components for cell selection in a high speed scenario in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

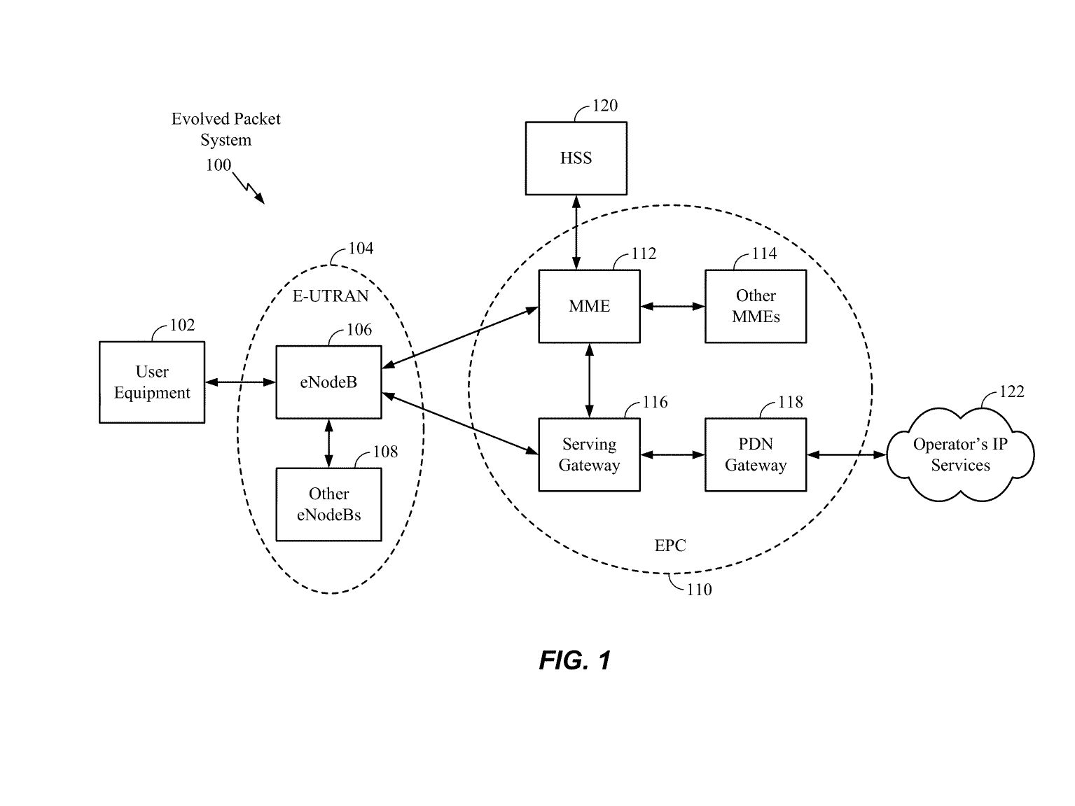

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

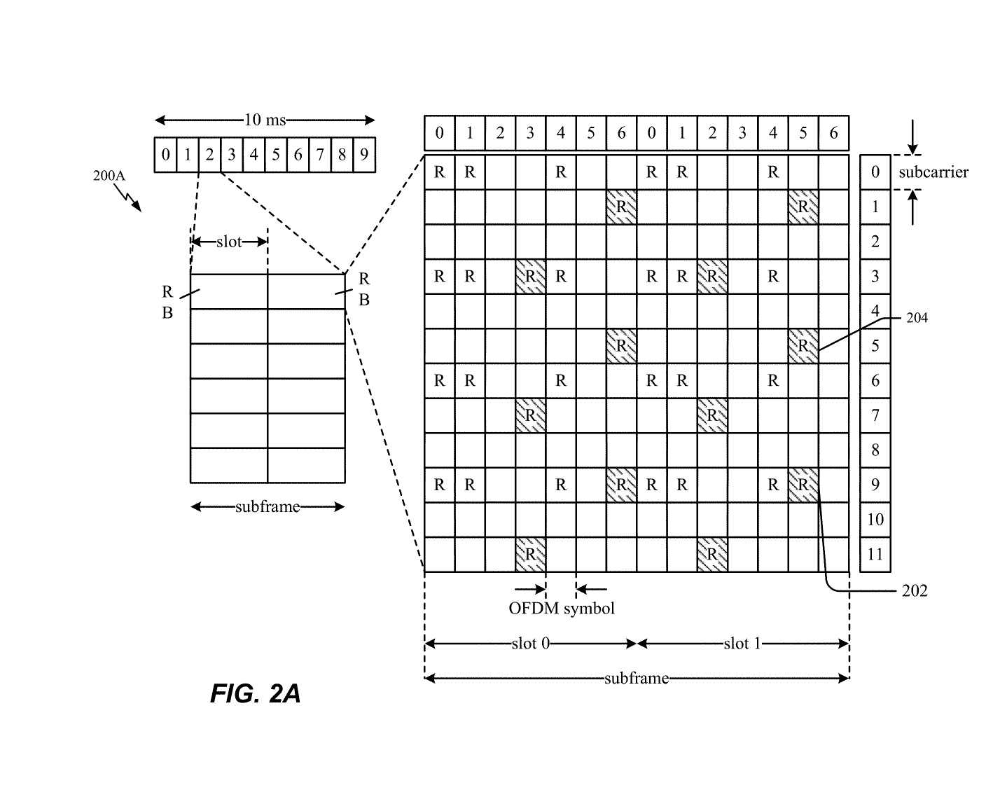

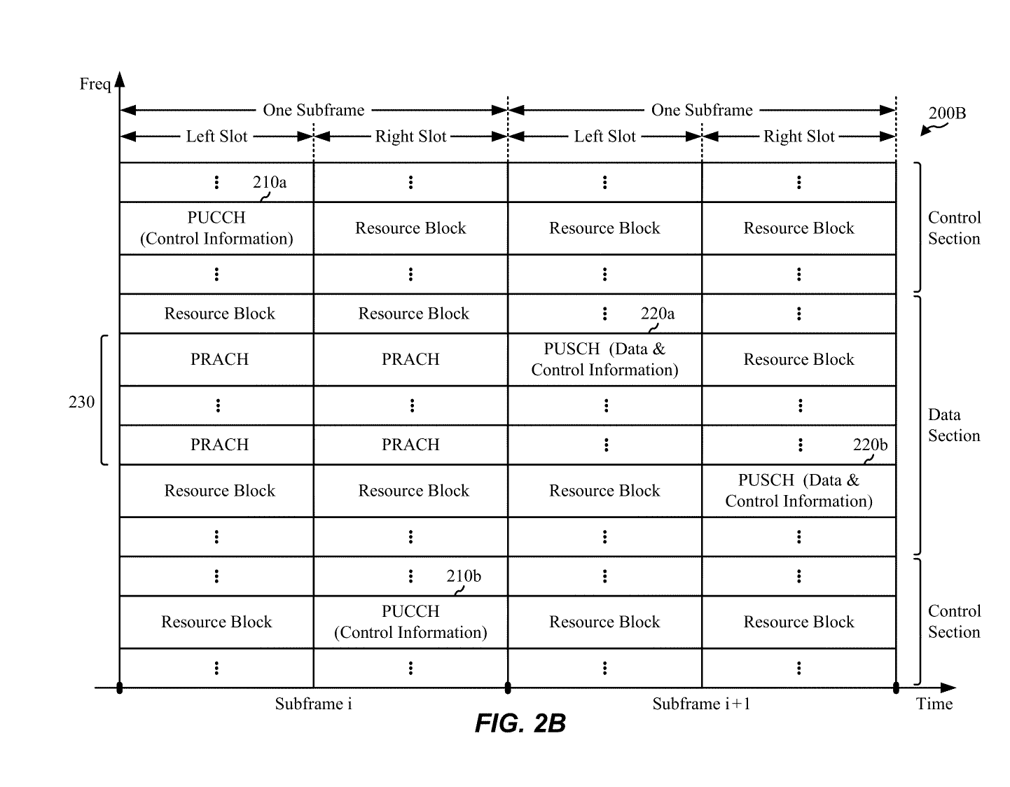

FIG. 2A is a diagram 200A illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

FIG. 2B is a diagram 200B illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 210a, 210b in the control section to transmit control information to an eNodeB. The UE may also be assigned resource blocks 220a, 220b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 230. The PRACH 230 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

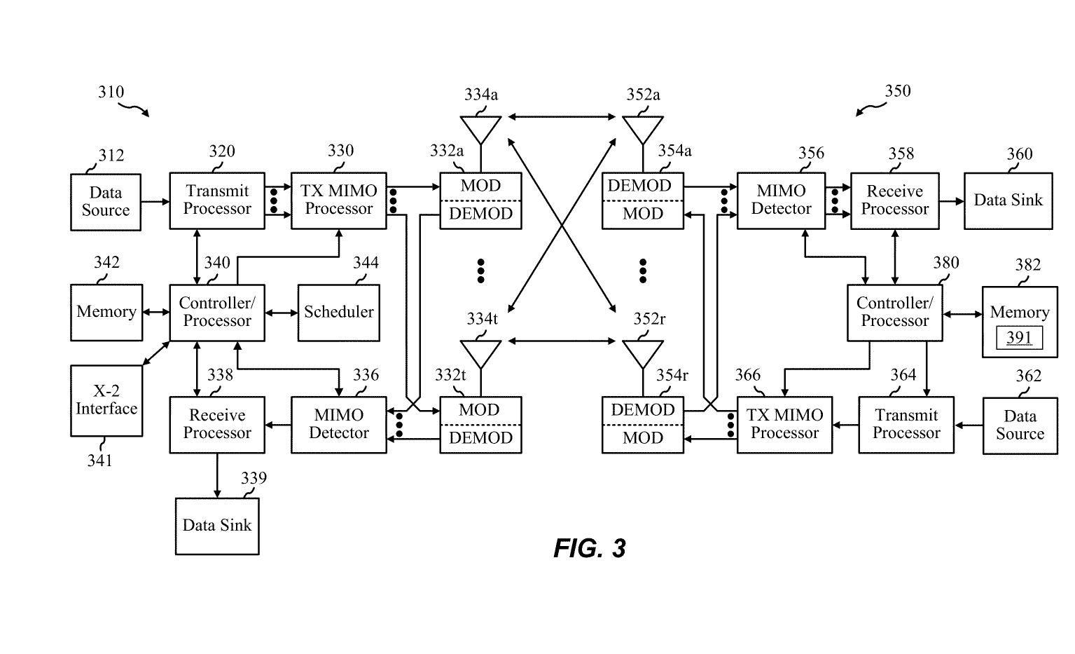

FIG. 3 shows a block diagram of a design of a base station 310 and a UE 350, which may be one of the base stations/eNodeBs and the UE in FIG. 1. For example, the base station 310 may be the macro eNodeB 106 in FIG. 1, and the UE 350 may be the UE 102 of FIG. 1. The base station 310 may also be a base station of some other type. The base station 310 may be equipped with antennas 334a through 334t, and the UE 350 may be equipped with antennas 352a through 352r.

At the base station 310, a transmit processor 320 may receive data from a data source 312 and control information from a controller/processor 340. The control information may be for the physical broadcast channel (PBCH), physical control format indicator channel (PCFICH), physical hybrid-ARQ indicator channel (PHICH), physical downlink control channel (PDCCH), etc. The data may be for the physical downlink shared channel (PDSCH), etc. The processor 320 may process (e.g., encode and symbol map) the data and control information to obtain data symbols and control symbols, respectively. The processor 320 may also generate reference symbols, e.g., for the primary synchronization signal (PSS), secondary synchronization signal (SSS), and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 350, the antennas 352a through 352r may receive the downlink signals from the base station 310 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 350 to a data sink 360, and provide decoded control information to a controller/processor 380.

On the uplink, at the UE 350, a transmit processor 364 may receive and process data (e.g., for the physical uplink shared channel (PUSCH)) from a data source 362 and control information (e.g., for the physical uplink control channel (PUCCH)) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 310. At the base station 310, the uplink signals from the UE 350 may be received by the antennas 334, processed by the demodulators 332, detected by a MIMO detector 336 if applicable, and further processed by a receive processor 338 to obtain decoded data and control information sent by the UE 350. The processor 338 may provide the decoded data to a data sink 339 and the decoded control information to the controller/processor 340. The base station 310 can send messages to other base stations, for example, over an X2 interface 341.

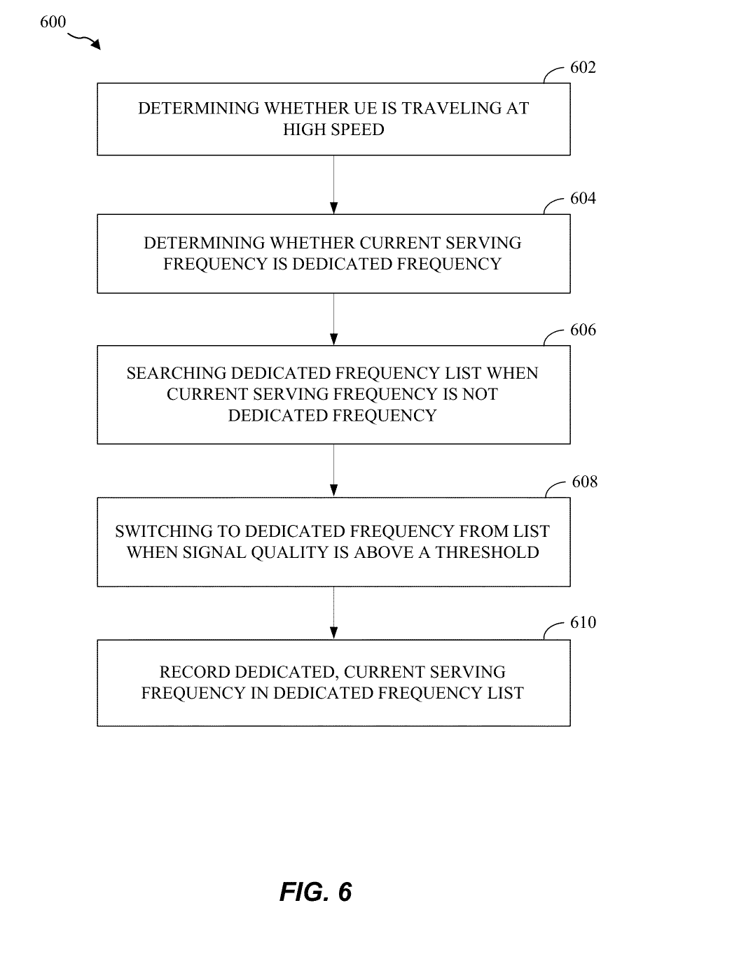

The controllers/processors 340 and 380 may direct the operation at the base station 310 and the UE 350, respectively. The processor 340/380 and/or other processors and modules at the base station 310/UE 350 may perform or direct the execution of the functional blocks illustrated in method flow chart FIG. 6 and/or other processes for the techniques described herein. A scheduler 344 may schedule UEs for data transmission on the downlink and/or uplink. The memories 342 and 382 may store data and program codes for the base station 310 and the UE 350, respectively. For example, the memory 382 of the UE 350 may store a cell selection module 391 for high-speed scenarios, which, when executed by the controller/processor 380, configures the UE 350 to select a target cell in a dedicated network.

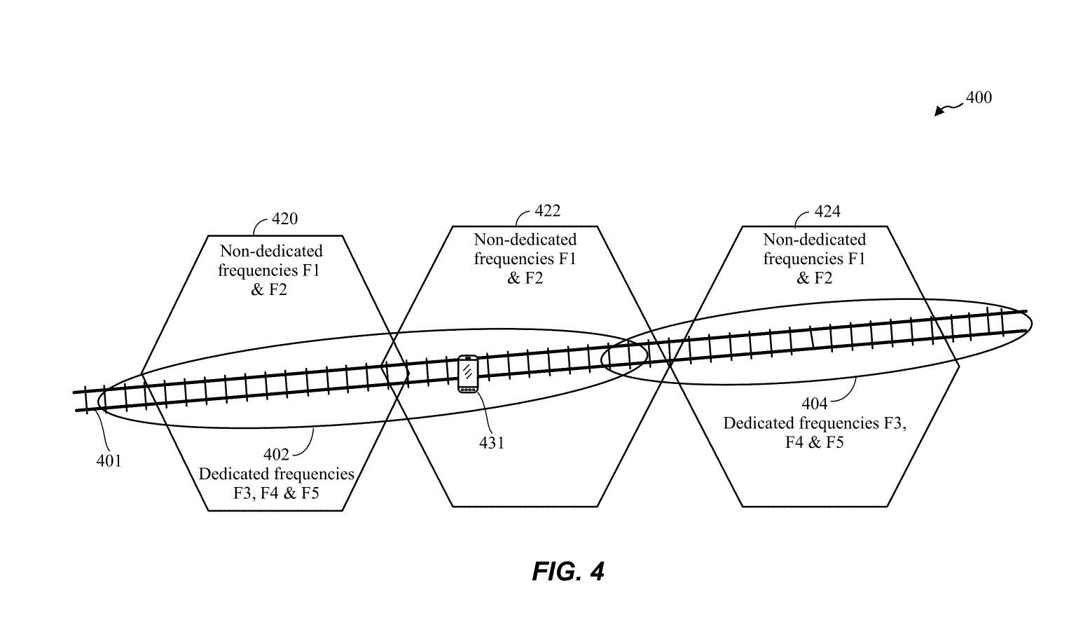

FIG. 4 illustrates a network coverage area example 400 including a dedicated wireless network and a non-dedicated, public wireless network, according to aspects of the present disclosure. In one example, both the dedicated and non-dedicated wireless networks are LTE or other types of networks, including public and dedicated LTE cells. In the following description, LTE networks will be discussed, although the present disclosure contemplates other types of wireless networks.

In the example of FIG. 4, public cells include cells 420, 422 and 424. The dedicated cells include cells 402 and 404. Different LTE frequencies are used for public LTE cells 420, 422 and 424 and dedicated LTE cells 402 and 404. For example, LTE frequencies F1 and F2 may be used for the public LTE cells 420, 422 and 424, as shown in the example 400, and LTE frequencies F3, F4 and F5 are for the dedicated LTE cells 402 and 404.

According to one aspect of the present disclosure, the dedicated cells 402 and 404 are configured in such a way that they are elongated to focus coverage around the train track 401 to serve UEs on high speed trains, such as the UE 431. In contrast, non-dedicated cells, such as the public cells 420, 422 and 424, are configured to cover a more general area. As a result of the different configurations, a dedicated, elongated cell covers a larger area along the train track 401 than a non-dedicated cell. The elongated configuration of a dedicated cell may be achieved via beam forming of directional antennas of the dedicated cells and other techniques.

Handover or cell reselection may be performed when the UE 431 moves from one dedicated cell to another, such as from the cell 402 to the cell 404. A handover or cell reselection may also be performed when the UE moves from the coverage of one radio access technology (RAT) to the coverage area of another RAT (not shown), when there is a coverage hole or lack of coverage in one network, when there is traffic balancing between a first RAT and a second RAT networks, or when one network does not support a desired service (e.g., circuit switched calls in a circuit switched fall back scenario).

As part of a handover while in a connected mode with a dedicated network (e.g., LTE or TD-LTE) the UE 431 may be specified to perform a measurement of a neighboring cell. For example, the UE 431 may measure the neighbor cell, such as the cell 404, for signal strength, frequency channel, and base station identity code (BSIC), etc. Such measurement may be referred to as intra radio access technology measurement.

The UE 431 may send the serving cell, such as the cell 402, a measurement report indicating results of the measurement performed by the UE 431. The serving cell may then trigger a handover of the UE 431 to a new cell based on the measurement report. The measurement may include a serving cell signal strength, such as a received signal code power (RSCP) for a pilot channel (e.g., primary common control physical channel (PCCPCH)). The signal strength is compared to a serving cell threshold. The serving cell threshold can be indicated to the UE through dedicated radio resource control (RRC) signaling from the network. The measurement may also include a neighbor cell received signal strength indicator (RSSI). The neighbor cell signal strength can be compared with a neighbor cell threshold.

### Cell Selection in a High Speed Scenario

It is desirable that a UE, such as the UE 431, on a high speed train stay on the dedicated network to fully utilize the dedicated network resources and to ensure quality of service (QoS) of wireless service in a high speed scenario. However, for one reason or another, the UE may leave the dedicated network unintentionally or prematurely and connect to a non-dedicated network. Because there are no neighbor frequencies configured between a dedicated LTE frequency and a public LTE frequency, once a UE in a high speed scenario leaves the dedicated LTE frequency, it may be difficult for the UE to return to the dedicated LTE frequency.

The UE in a high speed train may leave a dedicated LTE frequency for various reasons. One such reason is lack of dedicated LTE frequency coverage in some area. Another reason is that a public, non-dedicated LTE frequency has stronger coverage due to the site limitation of the dedicated LTE frequency. Yet another reason for departing the dedicated network is an equipment error, such as the radio resource unit (RRU) of the dedicated LTE network failing. An efficient way for the UE to return to a dedicated frequency is desired.

A UE may first determine whether it is in a high speed scenario. Once the UE determines it is in a high speed scenario, the UE determines whether it is camping on a dedicated frequency.

There are a few ways for the UE to determine whether a UE is in a high speed scenario (e.g., travelling at a high speed while on the high speed train). Such a determination may be based on GPS input or measured average Doppler frequency. The determination can also be based on unusually frequent cell reselections or handoffs. That is, if the UE is handing off or reselecting more often than normal, the UE may be in a high speed scenario. Similarly, if tracking area updates occur more frequently than normal, the UE may be in a high speed scenario. Tracking area updates occur when a UE leaves a coverage area of a core network element (e.g., mobility management entity (MME)), among other reasons.

While in a high speed scenario, the UE also determines whether it is on a dedicated frequency. The determination can be based on a number of cell reselections, tracking area updates and/or handovers that have occurred within a predefined time window. For example, when the UE is in a high speed scenario and camping on a public LTE frequency, the UE will perform frequent tracking area updates (TAUs). If the number of tracking area updates is above a predetermined threshold within a predefined time window, the UE may recognize that it may not be on a dedicated frequency while traveling at high speed. Similarly, if the UE detects that a large number of cell reselections or handovers occur within a predefined time window, the UE may recognize that it may not be on a dedicated frequency while traveling at high speed.

According to one aspect of the present disclosure, when the UE is in a high speed scenario, the UE records dedicated serving LTE frequencies in a dedicated frequency list. If the current serving frequency is not listed in a dedicated LTE frequency list, the UE may recognize that it might not be on a dedicated frequency.

If the UE determines it is not on a dedicated frequency, the UE may start to periodically search dedicated LTE frequencies recorded in the dedicated frequency list. These frequencies likely are not indicated by the current serving non-dedicated LTE cell as neighbors. If a suitable LTE cell from the list is detected, the UE may select the cell and initiate a procedure to return to the dedicated LTE frequency.

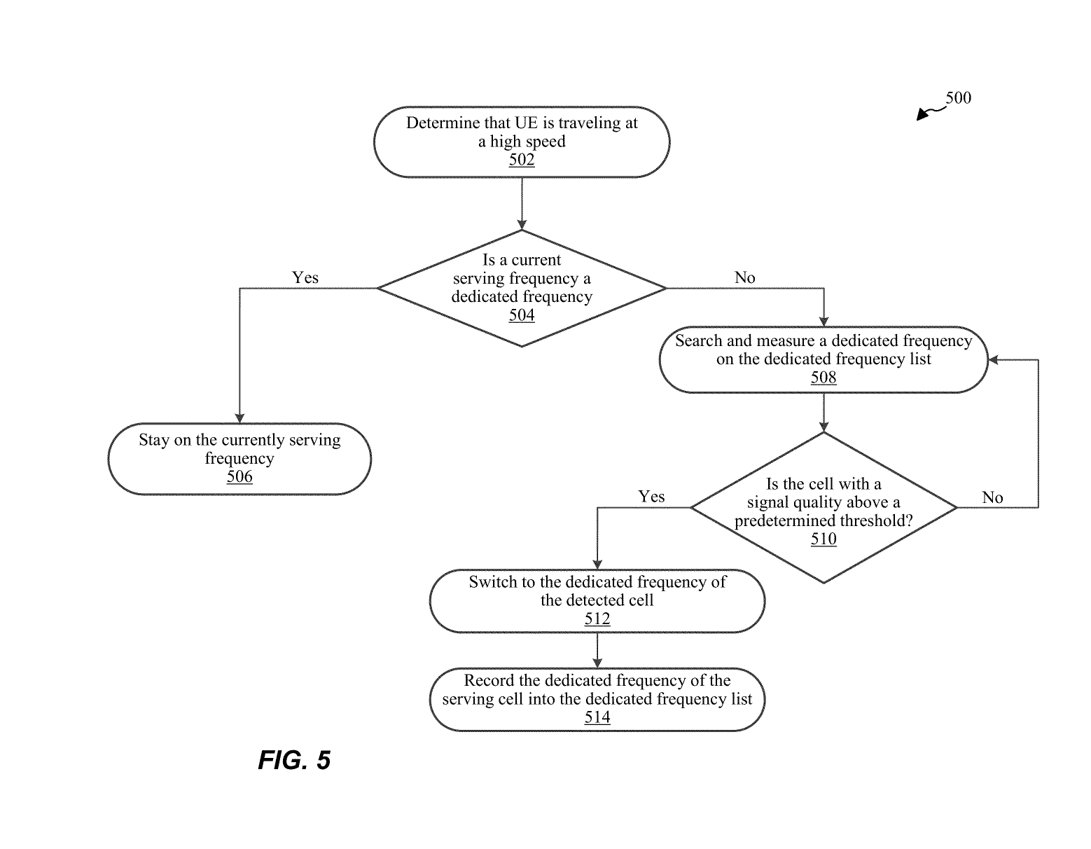

FIG. 5 shows a flow diagram 500 illustrating, as an example, a decision process for a cell selection method at a UE in a high speed scenario, according to aspects of the present disclosure. The flow diagram 500 is for illustration purposes only and other alternative aspects of the decision process for the cell selection in a high speed scenario are certainly possible.

At block 502, the UE first determines whether it is traveling at a high speed, such as riding on a high speed train. The UE may determine whether it is on a high speed train via various techniques, such as a measurement of a filtered Doppler frequency, a measurement input from a GPS unit, a recorded number of handoffs or cell reselections within a given time period, and/or a number of tracking area updates (TAUs) within a time window.

Once the UE determines it is traveling at a high speed, at block 504, the UE further determines whether the current serving frequency is a dedicated frequency of a dedicated network. The UE may determine this using one or more of a variety of methods. The methods, for example, may include checking a dedicated frequency list that is stored in a buffer at the UE (e.g., UE buffer), counting the number of tracking area updates within a time window, and counting the number of cell reselections and/or handovers within another time window, among others. The purpose of determining whether the current serving frequency is a dedicated frequency is to determine whether the UE is on a dedicated network.

If the UE determines that the current serving frequency is a dedicated frequency, at block 506, the UE may stay on the current dedicated frequency. It is desirable for the UE in a high speed scenario to stay on the dedicated network.

If the UE determines that the current serving frequency is not a dedicated frequency, it may mean that the UE has left the dedicated network for one reason or another. Generally, a public network cell does not list dedicated network frequencies as neighbors. Rather, only other public frequencies are listed as neighbors of a public cell. However, at block 508, instead of searching for a frequency of a neighbor cell, as the UE would normally do when the UE desires to switch to a different cell, the UE periodically searches the dedicated frequencies in the dedicated frequency list to find a suitable dedicated cell.

At decision block 510, the UE measures the signal quality of a frequency in the dedicated frequency list that the UE has found and determines whether the signal quality is above a predetermined threshold. If the signal quality is not above the predetermined threshold, the UE returns to block 508 and searches for another frequency in the dedicated frequency list. If no dedicated frequency is detected (not shown in FIG. 5), the UE may remain on the public frequency for a period of time before searching for another dedicated frequency.

If the signal quality of the frequency from the dedicated frequency list is above the predetermined threshold, at block 512, the UE may initiate a cell reselection procedure to switch to the suitable dedicated cell. In other words, the UE initiates a procedure to return to the dedicated network for the high speed train from which the UE left for one reason or another. This way, the UE may return to the dedicated network efficiently and in a speedy manner.

At block 514, the UE may record in the dedicated frequency list the dedicated frequency to which it just switched. Therefore, the UE may reuse this or other dedicated frequencies in a similar situation when the UE should return to the dedicated network the next time.

FIG. 6 is a flow diagram illustrating a method 600 at a UE for cell selection in a high speed scenario. At block 602, the UE may first determine whether it is traveling at a high speed, such as riding on a high speed train. The UE may determine its speed via one or more of a variety of methods including a measurement of a filtered Doppler frequency, a measurement input from a GPS unit, a recorded number of cell reselections or handovers within a given time period, and/or a number of tracking area updates (TAUs) within a time window.

At block 604, the UE determines whether a current serving frequency is a dedicated frequency. That is, once the UE determines that it is in a high speed scenario (traveling faster than a predetermined speed) at block 602, the UE, at block 604, may attempt to determine whether it is on a dedicated network. The UE may determine the current serving frequency is not a dedicated frequency when a number of tracking area updates within a predetermined time window is above a predetermined threshold. If the UE is on the dedicated network, the tracking area updates in general may not be very frequent because the dedicated network is designed and configured in such a way that the coverage area is focused along a train track and covers an area along the track larger than a non-dedicated, public network, as shown in FIG. 4. Therefore, if the number of tracking area updates is above a predetermined threshold, it indicates that the UE may be on a non-dedicated, public network.

The UE may also determine that the current serving frequency is dedicated when a high-speed flag for the current serving frequency is set in a received message. The received message may be a broadcast system information message and/or a dedicated signaling message. A dedicated base station in a high-speed scenario may set the high-speed flag for the current serving frequency in a broadcast message or a dedicated signaling message sent to the UE. Similarly, the UE may also determine that the current serving frequency is not dedicated when the high-speed flag for the current serving frequency is not set in the broadcast system information message and/or the dedicated signaling message.

The UE may also determine that the current serving frequency is not a dedicated frequency when the number of reselections and/or handovers within a predefined time window is above a predetermined threshold (e.g., a second predetermined threshold). Similar to the tracking area updates, reselections and handovers for the UE in a dedicated network in a high speed scenario are not as frequent as in a non-dedicated, public network, because the dedicated network cell covers more area along the train track than a non-dedicated cell. The UE may also determine that the current serving frequency may not be a dedicated frequency when the serving frequency is not in the dedicated frequency list. Additionally, the UE may also determine the current serving frequency is not a dedicated frequency when a number of cell reselections or handovers within a predefined time window is above a predetermined threshold (e.g., third predetermined threshold.)

When the UE determines that the current serving frequency is not a dedicated frequency, at block 606, the UE tries to return to the dedicated network by periodically searching each dedicated frequency in the dedicated frequency list. Searching the dedicated frequency facilitates detecting of a suitable cell of the dedicated network for the UE. Once a dedicated frequency in the dedicated frequency list is found, the UE may measure the signal quality of corresponding dedicated cells. When the measured signal quality is above a predetermined threshold, a suitable cell is detected for the UE.

At block 608, the UE switches to the dedicated frequency when the signal quality of the dedicated frequency is above the predetermined threshold. The UE in effect initiates a reselection procedure from the current serving cell of a public, non-dedicated network to the detected, suitable cell of the dedicated network.

At block 610, the UE records the dedicated frequency and the suitable cell information in the dedicated frequency list to facilitate future use of the dedicated frequencies by the UE. In addition to recording the dedicated frequency, the UE may also record a non-dedicated frequency in a non-dedicated frequency list. In one example, the non-dedicated frequency list is an acquisition history. In one aspect of the present disclosure, the dedicated frequency list and the non-dedicated frequency list are implemented in a similar fashion.

Therefore, the method 600 provides an efficient way for the UE riding on a high speed train to return to the dedicated network after the UE left the dedicated network, for one reason or another.

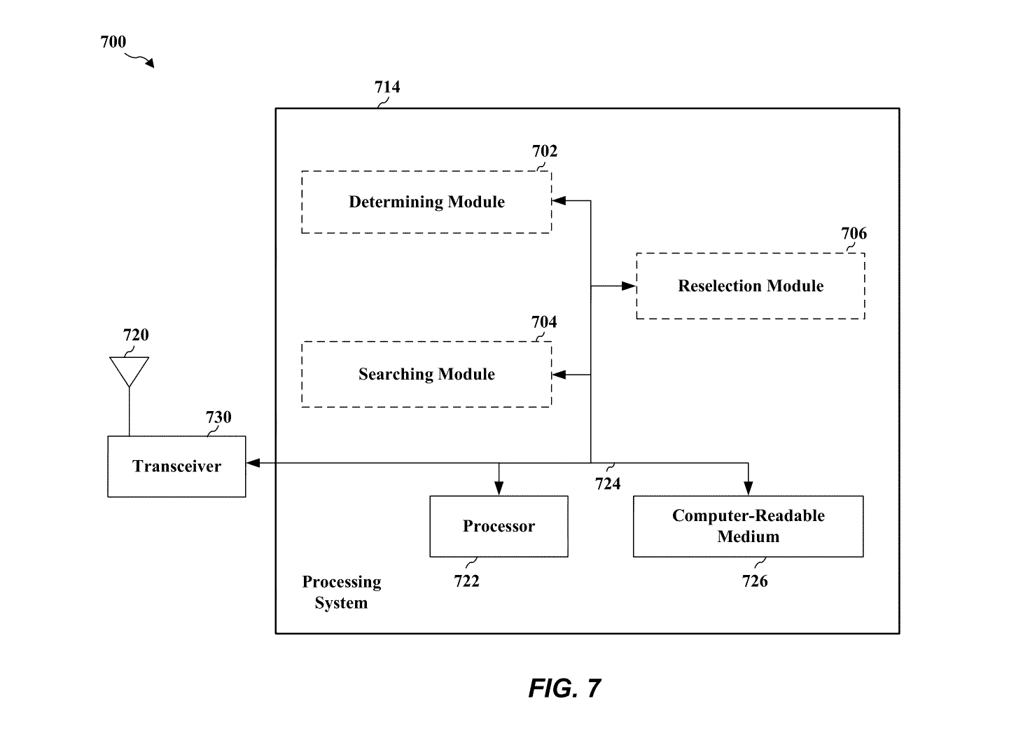

FIG. 7 is a block diagram illustrating an example of a hardware implementation for an apparatus 700 employing a processing system 714 with different modules/means/components for fast return failure handling in a high speed scenario in an example apparatus according to one aspect of the present disclosure. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the non-transitory computer-readable medium 726. The bus 724 may also link various other circuits, such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a determining module 702 for determining a speed of the UE and determining whether a current serving frequency is a dedicated frequency. The processing system 714 also includes a searching module 704 for searching dedicated frequencies from a dedicated frequency list. The processing system 714 may also include a reselection module 706 for switching to a dedicated cell of a dedicated network. The modules 702, 704 and 706 may be software modules running in the processor 722, resident/stored in the computer-readable medium 726, one or more hardware modules coupled to the processor 722, or some combination thereof. The processing system 714 may be a component of the UE 350 of FIG. 3 and may include the memory 382, and/or the controller/processor 380.

In one configuration, an apparatus, such as a UE 350, is configured for wireless communication including means for determining a UE is traveling at a high speed and for determining that a current serving frequency is a dedicated frequency. In one aspect, the determining means may be the antennas 352, the receive processor 358, the controller/processor 380, the memory 382, the cell selection module 391, the determining module 702, and/or the processing system 714 configured to perform the functions recited by the determining means. In one configuration, the means and functions correspond to the aforementioned structures. In another aspect, the aforementioned means may be a module or any apparatus configured to perform the functions recited by the determining means.

Optionally, an apparatus, such as a UE 350, is configured for wireless communication and includes a means for recording the current serving frequency into a dedicated frequency list when the UE is traveling faster than the predetermined speed and the current serving frequency is dedicated or when the high-speed flag for the current serving frequency is set in the received message.

The UE 350 is also configured to include means for searching frequencies from a dedicated frequency list. In one aspect, the searching means may include the antennas 352, the receive processor 358, the controller/processor 380, the memory 382, the cell selection module 391, the searching module 704, and/or the processing system 714 configured to perform the functions recited by the searching means. In one configuration, the means and functions correspond to the aforementioned structures. In another aspect, the aforementioned means may be a module or any apparatus configured to perform the functions recited by the searching means.

The UE 350 is also configured to include means for switching to a dedicated frequency of a suitable dedicated cell. In one aspect, the switching means may include the antennas 352, the receive processor 358, the transmit processor 364, the controller/processor 380, the memory 382, the cell selection module 391, the reselection module 706, and/or the processing system 714 configured to perform the functions recited by the switching means. In one configuration, the means and functions correspond to the aforementioned structures. In another aspect, the aforementioned means may be a module or any apparatus configured to perform the functions recited by the switching means.

Several aspects of a telecommunications system has been presented with reference to TD-SCDMA and LTE (in FDD, TDD, or both modes). As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other systems, such as or LTE-advanced (LTE-A), W-CDMA, high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric, such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
determining whether a user equipment (UE) is traveling faster than a predetermined speed;
determining whether a current serving frequency is dedicated, based on whether the UE is traveling faster than the predetermined speed and/or whether a high-speed flag is set in a received message, in which the serving frequency is dedicated when the serving frequency is exclusive for use in a high-speed transportation system and does not have a neighbor frequency relationship configured with a public, non-dedicated frequency;
periodically searching a dedicated frequency from a dedicated frequency list to detect a dedicated cell with a signal quality above a first predetermined threshold, when the current serving frequency is not dedicated; and
switching to the dedicated cell, when the signal quality of the dedicated cell is above the first predetermined threshold.

2. The method of claim 1, in which the determining comprises determining the current serving frequency is dedicated when the high-speed flag for the current serving frequency is set and in which the received message is a broadcast system information message or a dedicated signaling message.

3. The method of claim 1, in which the determining comprises determining the current serving frequency is not dedicated when a number of tracking area updates (TAUs) within a predefined time window is above a second predetermined threshold or when a number of cell reselections or handovers within the predefined time window is above a third predetermined threshold.

4. The method of claim 1, in which the determining comprises determining the current serving frequency is not dedicated when the current serving frequency is not in the dedicated frequency list stored in a UE buffer.

5. The method of claim 1, in which the determining comprises determining the current serving frequency is not dedicated when the high-speed flag for the current serving frequency is not set in the received message.

6. The method of claim 1, further comprising recording the current serving frequency into the dedicated frequency list when at least one of:
the UE is traveling faster than the predetermined speed and the current serving frequency is dedicated, or
the high-speed flag for the current serving frequency is set in the received message.

7. The method of claim 1, further comprising recording the current serving frequency into a non-dedicated frequency list at the UE when at least one of:
the UE is not traveling faster than the predetermined speed, or
the high-speed flag for the current serving frequency is not set in the received message.

8. An apparatus for wireless communication, comprising:
a memory; and
at least one processor coupled to the memory and configured:
to determine whether a user equipment (UE) is traveling faster than a predetermined speed;
to determine whether a current serving frequency is dedicated, based on whether the UE is traveling faster than the predetermined speed and/or whether a high-speed flag is set in a received message, in which the serving frequency is dedicated when the serving frequency is exclusive for use in a high-speed transportation system and does not have a neighbor frequency relationship configured with a public, non-dedicated frequency;
to periodically search a dedicated frequency from a dedicated frequency list to detect a dedicated cell with a signal quality above a first predetermined threshold, when the current serving frequency is not dedicated; and
to switch to the dedicated cell, when the signal quality of the dedicated cell is above the first predetermined threshold.

9. The apparatus of claim 8, in which the at least one processor is further configured to determine the current serving frequency is dedicated if the high-speed flag for the current serving frequency is set and in which the received message is a broadcast system information message and/or a dedicated signaling message.

10. The apparatus of claim 8, in which the at least one processor is further configured to determine the current serving frequency is not dedicated when a number of tracking area updates (TAUs) within a predefined time window is above a second predetermined threshold or when a number of cell reselections or handovers within the predefined time window is above a third predetermined threshold.

11. The apparatus of claim 8, in which the at least one processor is further configured to determine the current serving frequency is not dedicated when the current serving frequency is not in the dedicated frequency list stored in a UE buffer.

12. The apparatus of claim 8, in which the at least one processor is further configured to determine the current serving frequency is not dedicated when the high-speed flag for the current serving frequency is not set in the received message.

13. The apparatus of claim 8, in which the at least one processor is further configured to record the current serving frequency into the dedicated frequency list when the UE is traveling faster than the predetermined speed and the current serving frequency is dedicated, or when the high-speed flag for the current serving frequency is set in the received message.

14. The apparatus of claim 8, in which the at least one processor is further configured to record the current serving frequency into a non-dedicated frequency list at the UE when the UE is not traveling faster than the predetermined speed or when the high-speed flag for the current serving frequency is not set in the received message.

15. An apparatus of a wireless communication, comprising:
means for determining whether a user equipment (UE) is traveling faster than a predetermined speed;
means for determining whether a current serving frequency is dedicated, based on whether the UE is traveling faster than the predetermined speed and/or whether a high-speed flag is set in a received message, in which the serving frequency is dedicated when the serving frequency is exclusive for use in a high-speed transportation system and does not have a neighbor frequency relationship configured with a public, non-dedicated frequency;
means for periodically searching a dedicated frequency from a dedicated frequency list to detect a dedicated cell with a signal quality above a first predetermined threshold, when the current serving frequency is not dedicated; and
means for switching to the dedicated cell, when the signal quality of the dedicated cell is above the first predetermined threshold.

16. The apparatus of claim 15, in which the means for determining whether the current serving frequency is dedicated comprises means for determining the current serving frequency is dedicated if the high-speed flag for the current serving frequency is set and in which the received message is a broadcast system information message and/or a dedicated signaling message.

17. The apparatus of claim 15, in which the means for determining whether the current serving frequency is dedicated comprises means for determining the current serving frequency is not dedicated when a number of tracking area updates (TAUs) within a predefined time window is above a second predetermined threshold or when a number of cell reselections or handovers within the predefined time window is above a third predetermined threshold.

18. The apparatus of claim 15, in which the means for determining whether the current serving frequency is dedicated comprises means for determining the current serving frequency is not dedicated when the current serving frequency is not in the dedicated frequency list stored in a UE buffer.

19. The apparatus of claim 15, in which the means for determining whether the current serving frequency is dedicated comprises means for determining the current serving frequency is not dedicated when the high-speed flag for the current serving frequency is not set in the received message.

20. The apparatus of claim 15, further comprising means for recording the current serving frequency into the dedicated frequency list when the UE is traveling faster than the predetermined speed and the current serving frequency is dedicated or when the high-speed flag for the current serving frequency is set in the received message.

21. The apparatus of claim 15, further comprising means for recording the current serving frequency into a non-dedicated frequency list at the UE when the UE is not traveling faster than the predetermined speed or when the high-speed flag for the current serving frequency is not set in the received message.

22. A computer program product for wireless communication, comprising:
a non-transitory computer-readable medium having encoded thereon program code, the program code comprising:
program code to determine whether a user equipment (UE) is traveling faster than a predetermined speed;
program code to determine whether a current serving frequency is dedicated, based on whether the UE is traveling faster than the predetermined speed and/or whether a high-speed flag is set in a received message, in which the serving frequency is dedicated when the serving frequency is exclusive for use in a high-speed transportation system and does not have a neighbor frequency relationship configured with a public, non-dedicated frequency;
program code to periodically search a dedicated frequency from a dedicated frequency list to detect a dedicated cell with a signal quality above a first predetermined threshold, when the current serving frequency is not dedicated; and
program code to switch to the dedicated cell, when the signal quality of the dedicated cell is above the first predetermined threshold.

23. The computer program product of claim 22, in which the program code to determine whether the current serving frequency is dedicated determines the current serving frequency is dedicated if the high-speed flag for the current serving frequency is set and in which the receive message is a broadcast system information message and/or a dedicated signaling message.

24. The computer program product of claim 22, in which the program code to determine whether the current serving frequency is dedicated determines the current serving frequency is not dedicated when a number of tracking area updates (TAUs) within a predefined time window is above a second predetermined threshold or when a number of cell reselections or handovers within the predefined time window is above a third predetermined threshold.

25. The computer program product of claim 22, in which the program code to determine whether the current serving frequency is dedicated determines the current serving frequency is not dedicated when the high-speed flag for the current serving frequency is not set in the received message.

26. The computer program product of claim 22, in which the program code to determine whether the current serving frequency is dedicated determines the current serving frequency is not dedicated when the current serving frequency is not in the dedicated frequency list stored in a UE buffer.

27. The computer program product of claim 22, further comprising program code to record the current serving frequency into the dedicated frequency list when the UE is traveling faster than the predetermined speed and the current serving frequency is dedicated or when the high-speed flag for the current serving frequency is set in the received message.

28. The computer program product of claim 22, further comprising program code to record the current serving frequency into a non-dedicated frequency list at the UE when the UE is not traveling faster than the predetermined speed or when the high-speed flag for the current serving frequency is not set in the received message.
